(19) United States
(12) Patent Application Publication
(10) Pub. No.: US 2014/0189516 A1
(43) Pub. Date: Jul. 3, 2014

(54) VIDEO PREVIEW DISPLAY METHOD AND TERMINAL DEVICE

(71) Applicant: Huawei Technologies Co., Ltd., Shenzhen (CN)

(72) Inventor: Qingying GUO, Shenzhen (CN)

(73) Assignee: Huawei Technologies Co., Ltd., Shenzhen (CN)

(21) Appl. No.: 14/096,880

(22) Filed: Dec. 4, 2013

Related U.S. Application Data
(63) Continuation of application No. PCT/CN2013/080679, filed on Aug. 2, 2013.

(30) Foreign Application Priority Data
Dec. 27, 2012 (CN) 201210578381.2

(51) Int. Cl. G06F 3/0482; G06F 3/0488

(52) U.S. Cl. CPC G06F 3/0482; G06F 3/0488
USPC 715/719

(57) ABSTRACT

The present disclosure provides a video preview display method and a terminal device, where the method includes: receiving a preview instruction of a required video selected by a user in a process of browsing a video menu, invoking a preview content of the required video according to the preview instruction and playing the preview content in a preview area of the video menu, where the preview area does not cover other videos in the video menu, so that the user can play the selected video while browsing the video menu and can select a video quickly and effectively, thereby greatly saving a video browsing time and simplifying an operation process.

### CROSS-REFERENCE TO RELATED APPLICATIONS

This application is a continuation of International Application No. PCT/CN2013/080679, filed on Aug. 2, 2013, which claims priority to Chinese Patent Application No. 201210578381.2, filed on Dec. 27, 2012, both of which are hereby incorporated by reference in their entireties.

### TECHNICAL FIELD

Embodiments of the present disclosure relate to the field of communications technologies, and in particular, to a video preview display method and a terminal device.

### BACKGROUND

When a user browses, by using a terminal device, a video menu on a user interface, pictures of all videos in the video menu are static and the user cannot know, merely according to the static pictures, video contents represented by the static pictures. Therefore, it is necessary to play a selected video to know whether the video content is actually needed. Currently, when clicking to play a video, the user needs to leave a previous video menu interface temporarily and plays the video on an individual video playing page in dynamic and full-screen mode. If the user finds that the video content is not actually needed after the video has been played in full-screen mode for a certain time, the user must exit a current video playing state and re-switch to the video menu state to continue to browse the video menu and perform selection again.

### SUMMARY

With respect to the foregoing defects in the prior art, embodiments of the present disclosure provide a video preview display method and a terminal device.

In a first aspect, the present disclosure provides a video preview display method, including:
receiving a preview instruction of a required video selected by a user in a process of browsing a video menu; and
invoking a preview content of the required video according to the preview instruction, and playing the preview content in a preview area of the video menu, where the preview area does not cover other videos in the video menu.

In a first possible implementation manner, the invoking a preview content of the required video according to the preview instruction and playing the preview content in a preview area of the video menu includes:
invoking, according to the preview instruction, a video segment captured from the required video, and playing the video segment in the preview area of the video menu.

In a second possible implementation manner, the invoking a preview content of the required video according to the preview instruction and playing the preview content in a preview area of the video menu includes:
invoking, according to the preview instruction, a preview segment formed by at least two key frames of the required video, and playing the preview segment in the preview area of the video menu.

With reference to the first aspect, the first possible implementation manner of the first aspect, and the second possible implementation manner of the first aspect, in a third possible implementation manner, in the process of playing in the preview area of the video menu, the method further includes:
receiving a video playing instruction, and playing the required video on a newly loaded playing interface according to the video playing instruction.

With reference to the first aspect, the first possible implementation manner of the first aspect, and the second possible implementation manner of the first aspect, in a fourth possible implementation manner, in the process of playing in the preview area of the video menu, the method further includes:
receiving a video exit instruction, stopping playing the preview content according to the video exit instruction, and restoring the required video to an initial display state for the user to browse.

In a second aspect, an embodiment of the present disclosure provides a terminal device, including:
a receiving module, configured to receive a preview instruction of a required video selected by a user in a process of browsing a video menu; and
a processing module, configured to invoke a preview content of the required video according to the preview instruction, and play the preview content in a preview area of the video menu, where the preview area does not cover other videos in the video menu.

In a first possible implementation manner, the processing module is specifically configured to:
invoke, according to the preview instruction, a video segment captured from the required video, and play the video segment in the preview area of the video menu.

In a second possible implementation manner, the processing module is specifically configured to:
invoke, according to the preview instruction, a preview segment formed by at least two key frames of the required video, and play the preview segment in the preview area of the video menu.

With reference to the second aspect, the first possible implementation manner of the second aspect, and the second possible implementation manner of the second aspect, in a third possible implementation manner, the receiving module is further configured to receive a video playing instruction in the process of playing in the preview area of the video menu; and
the processing module is further configured to play the required video on a newly loaded playing interface according to the video playing instruction.

With reference to the second aspect, the first possible implementation manner of the second aspect, and the second possible implementation manner of the second aspect, in a fourth possible implementation manner, the receiving module is further configured to receive a video exit instruction in the process of playing in the preview area of the video menu; and
the processing module is further configured to stop playing the preview content according to the video exit instruction, and restore the required video to an initial display state for the user to browse.

The video preview display method and the terminal device provided in the embodiments of the present disclosure, by receiving a preview instruction of a required video selected by a user in a process of browsing a video menu, invoking a preview content of the required video according to the preview instruction and playing the preview content in a preview area of the video menu, where the preview area does not cover other videos in the video menu, enable the user to play the selected video while browsing the video menu and to select a video quickly and effectively, thereby greatly saving a video browsing time and simplifying an operation process.

### BRIEF DESCRIPTION OF DRAWINGS

FIG. 1 is a flowchart of a video preview display method according to an embodiment of the present disclosure;

FIG. 2 is a schematic diagram of a video preview trigger manner according to an embodiment of the present disclosure;

FIG. 3 is a schematic diagram of a video preview area according to an embodiment of the present disclosure;

FIG. 4 is schematic structural diagram of a terminal device according to an embodiment of the present disclosure; and

FIG. 5 is schematic structural diagram of hardware of a terminal device according to an embodiment of the present disclosure.

### DESCRIPTION OF EMBODIMENTS

To make the objectives, technical solutions, and advantages of the embodiments of the present disclosure more comprehensible, the following clearly describes the technical solutions in the embodiments of the present disclosure with reference to the accompanying drawings in the embodiments of the present disclosure. Apparently, the described embodiments are merely a part rather than all of the embodiments of the present disclosure. All other embodiments obtained by a person of ordinary skill in the art based on the embodiments of the present disclosure without creative efforts shall fall within the protection scope of the present disclosure.

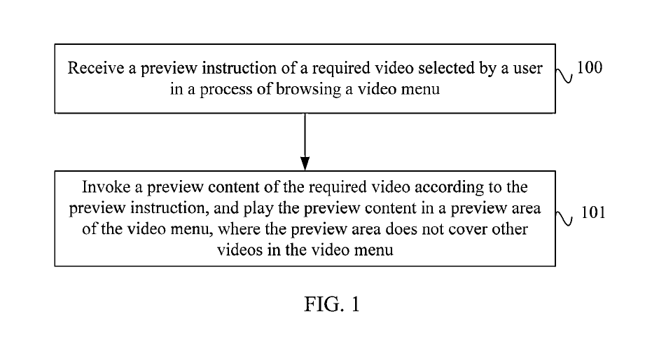

FIG. 1 is a flowchart of a video preview display method according to an embodiment of the present disclosure. As shown in FIG. 1, the method includes the following steps:

Step 100: Receive a preview instruction of a required video selected by a user in a process of browsing a video menu.

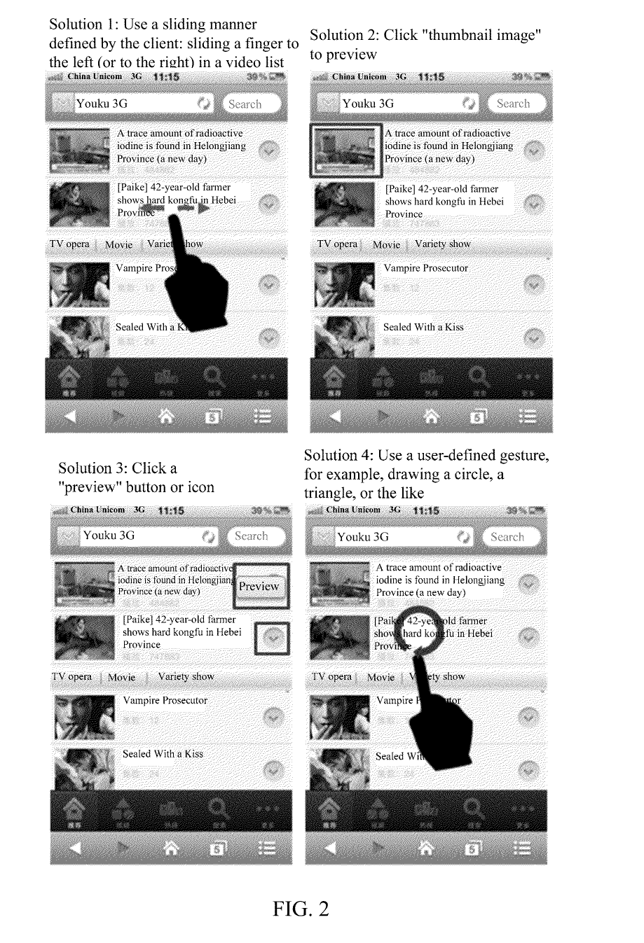

When the user browses the video menu by using a terminal device, each video file in the video menu has a file name and is played in the form of a static picture, where the static picture may be a first frame of the video content or a key frame that represents the video content. The user selects an interesting required video from the video menu, and sends a preview instruction of the required video to the terminal device. It should be noted that the terminal device may be a terminal device that supports user browsing such as a computer or a smart phone. The user can select an interesting required video from the video menu in many manners, and a specific manner may be designed according to an actual application requirement. FIG. 2 is a schematic diagram of a video preview trigger manner according to an embodiment of the present disclosure. As shown in FIG. 2, the specific trigger manner includes: sliding a finger across a screen, clicking a preview button, clicking a video file name, or using a user-defined gesture such as drawing a circle, a triangle, or the like.

Step 101: Invoke a preview content of the required video according to the preview instruction, and play the preview content in a preview area of the video menu, where the preview area does not cover other videos in the video menu.

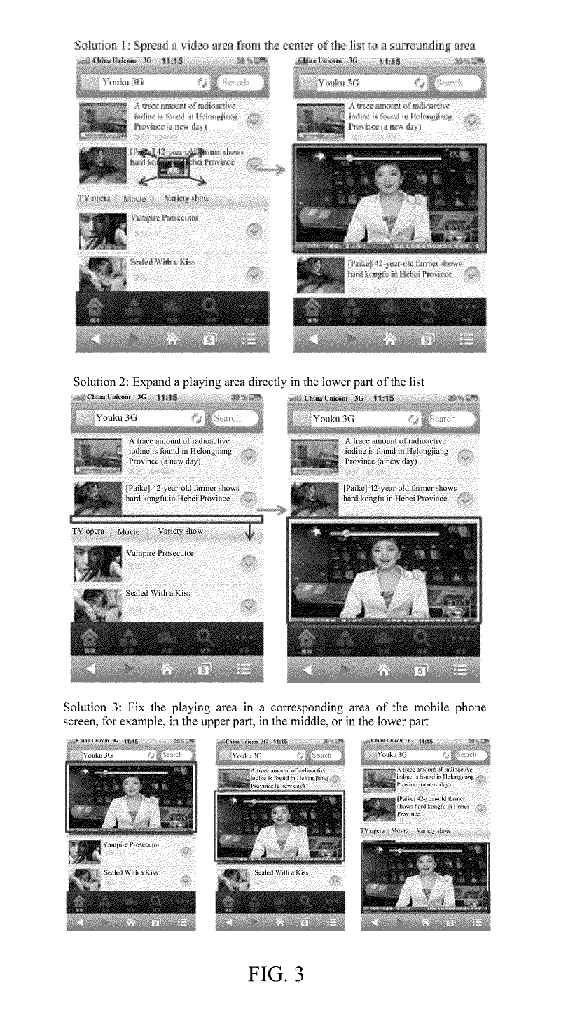

The terminal device invokes a preview content of the required video according to the preview instruction of the required video sent by the user, and plays the preview content in a preview area of the video menu, where the preview area does not cover other videos in the video menu. FIG. 3 is a schematic diagram of a video preview area according to an embodiment of the present disclosure. As shown in FIG. 3, on the premise that the preview area does not cover other videos in the video menu, the preview area may be designed in a specific area of the video menu according to an application requirement. The preview area specifically includes: a preview area spread from a display area occupied by a required video in a browsing state to a surrounding area, a preview area expanded directly from a display area occupied by a required video in a browsing state to the lower part of the display area, and a preview area always displayed in a specific area of the video menu, for example, in the upper part, in the middle, or in the lower part.

Specifically, the playing, by the terminal device, the preview content in the preview area of the video menu has many implementation manners The following describes two specific manners Manner 1: The terminal device invokes, according to a preview instruction, a video segment captured from the required video, and plays the video segment in the preview area of the video menu. Manner 2: The terminal device invokes, according to the preview instruction, a preview segment formed by at least two key frames of the required video, and plays the preview segment in the preview area of the video menu.

The video preview display method provided in this embodiment, by receiving a preview instruction of a required video selected by a user in a process of browsing a video menu, invoking a preview content of the required video according to the preview instruction and playing the preview content in a preview area of the video menu, where the preview area does not cover other videos in the video menu, enables the user to play the selected video while browsing the video menu and to select a video quickly and effectively, thereby greatly saving a video browsing time and simplifying an operation process.

Based on the foregoing embodiment, further, in the process of playing, by the terminal device, the preview content in the preview area of the video menu according to the preview instruction, the method further includes: if the user determines, according to the preview content, that the video is actually needed by the user, sending a video playing instruction to the terminal device, so that the terminal device plays the required video on a newly loaded playing interface according to the video playing instruction sent by the user.

Based on the foregoing embodiment, further, in the process of playing, by the terminal device, the preview content in the preview area of the video menu according to the preview instruction, the method further includes: if the user determines, according to the preview content, that the video is not actually needed by the user, sending a video exit instruction to the terminal device, so that the terminal device stops playing the required video according to the video exit instruction sent by the user and restores the required video to an initial display state for the user to browse.

A person of ordinary skill in the art may understand that, all or a part of the steps of the foregoing method embodiments may be implemented by a program instructing relevant hardware. The foregoing program may be stored in a computer readable storage medium. When the program runs, the foregoing steps in the method embodiments are performed. The foregoing storage medium may include any mediums capable of storing program codes, such as a ROM, a RAM, a magnetic disc, or an optical disc.

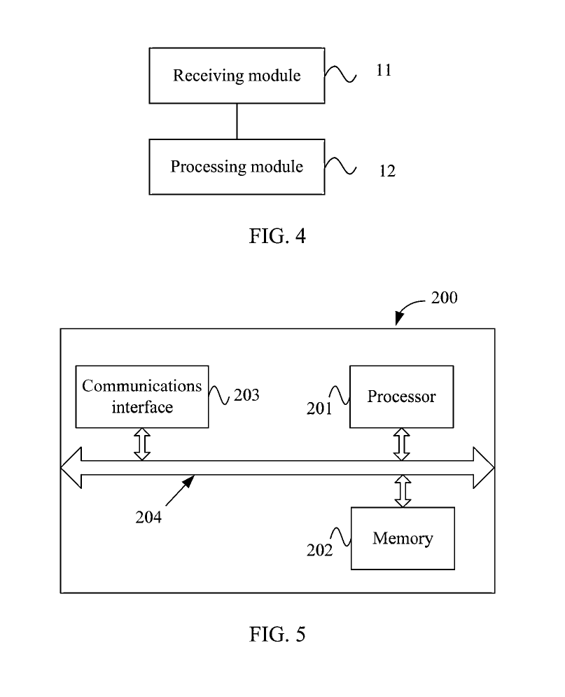

FIG. 4 is a schematic structural diagram of a terminal device according to an embodiment of the present disclosure. As shown in FIG. 4, the terminal device includes: a receiving module 11 and a processing module 12, where the receiving module 11 is configured to receive a preview instruction of a required video selected by a user in a process of browsing a video menu; the processing module 12 is configured to invoke a preview content of the required video according to the preview instruction and play the preview content in a preview area of the video menu, where the preview area does not cover other videos in the video menu.

For details about functions and processing processes of all modules in the terminal device provided in this embodiment, reference may be made to the method embodiment shown in FIG. 1. An implementation principle and a technical effect of the terminal device are similar to those of the foregoing method embodiment, which are not further described herein.

Specifically, the playing, by the terminal device, the preview content in the preview area of the video menu has many implementation manners The following describes two specific manners Manner 1: The processing module 12 is specifically configured to invoke, according to the preview instruction, a video segment captured from the required video, and play the video segment in the preview area of the video menu. Manner 2: The processing module 12 is specifically configured to invoke, according to the preview instruction, a preview segment formed by at least two key frames of the required video, and play the preview segment in the preview area of the video menu.

Based on the foregoing embodiment, further, the receiving module 11 is further configured to receive a video playing instruction in the process of playing in the preview area of the video menu; and the processing module 12 is further configured to play the required video on a newly loaded playing interface according to the video playing instruction.

Based on the foregoing embodiment, further, the receiving module 11 is further configured to receive a video exit instruction in the process of playing in the preview area of the video menu; and the processing module 12 is further configured to stop playing the preview content according to the video exit instruction, and restore the required video to an initial display state for the user to browse.

FIG. 5 is a schematic structural diagram of hardware of a terminal device according to an embodiment of the present disclosure. As shown in FIG. 5, the terminal device 200 includes a processor 201, a memory 202, a communications interface 203, and a bus 204. The processor 201, the memory 202, and the communications interface 203 are connected through the bus 204. The bus 204 may be an ISA bus, a PCI bus or an EISA bus, or the like. The bus may comprise an address bus, a data bus, a control bus, and the like. For convenience of representation, the bus in FIG. 5 is represented by using a solid line only, but it does not mean that there is only one bus or one type of bus.

The memory 202 is configured to store a program code, where the program code includes a computer operation instruction. The memory 202 may be a high-speed random access memory, and may also be a non-volatile memory (non-volatile memory), for example, at least one magnetic memory.

The processor 201 executes the program code and is configured to:
receive a preview instruction of a required video selected by a user in a process of browsing a video menu, invoke a preview content of the required video according to the preview instruction, and play the preview content in a preview area of the video menu, where the preview area does not cover other videos in the video menu.

The process of invoking a preview content of the required video according to the preview instruction and playing the preview content in a preview area of the video menu by the processor 201 specifically includes:
invoking, according to the preview instruction, a video segment captured from the required video, and playing the video segment in the preview area of the video menu; or
invoking, according to the preview instruction, a preview segment formed by at least two key frames of the required video, and playing the preview segment in the preview area of the video menu.

In the process of invoking a preview content of the required video according to the preview instruction and playing the preview content in a preview area of the video menu by the processor 201, the following step is further included:
receiving a video playing instruction, and playing the required video on a newly loaded playing interface according to the video playing instruction.

In the process of invoking a preview content of the required video according to the preview instruction and playing the preview content in a preview area of the video menu by the processor 201, the following step is further included:
receiving a video exit instruction, stopping playing the preview content according to the video exit instruction, and restoring the required video to an initial display state for the user to browse.

For details about the process of executing the program code in the memory by the processor in the terminal device, reference may be made to the foregoing method embodiment. An implementation principle and a technical effect of the processor are similar to those of the foregoing method embodiment, which are not further described herein.

Finally, it should be noted that the foregoing embodiments are merely intended for describing the technical solutions of the present disclosure other than limiting the present disclosure. Although the present disclosure is described in detail with reference to the foregoing embodiments, persons of ordinary skill in the art should understand that they may still make modifications to the technical solutions described in the foregoing embodiments, or make equivalent replacements to some technical features thereof, without departing from the spirit and scope of the technical solutions of the embodiments of the present disclosure.

1. A video preview display method, comprising:
receiving a preview instruction for a video selected by a user in a process of browsing a video menu;
invoking a preview content of the video according to the preview instruction; and
playing the preview content in a preview area of the video menu, wherein the preview area does not cover other videos in the video menu.

2. The video preview display method according to claim 1, wherein the invoking a preview content of the video according to the preview instruction and playing the preview content in a preview area of the video menu comprises:
invoking, according to the preview instruction, a video segment captured from the video, and playing the video segment in the preview area of the video menu.

3. The video preview display method according to claim 1, wherein the invoking a preview content of the video according to the preview instruction and playing the preview content in a preview area of the video menu comprises:
invoking, according to the preview instruction, a preview segment formed by at least two frames of the required video, and playing the preview segment in the preview area of the video menu.

4. The video preview display method according to claim 1, wherein the method further comprises:
receiving, while the preview content is playing in a preview area of the video menu, a video playing instruction, and
playing the selected video on a newly loaded playing interface according to the video playing instruction.

5. The video preview display method according to claim 1, wherein the method further comprises:
receiving, while the preview content is playing in a preview area of the video menu, a video exit instruction,
stopping the playing of the preview content, and
restoring the video to an initial display state.

6. A terminal device, comprising:
a receiving module, configured to receive a preview instruction for a video selected by a user in a process of browsing a video menu; and
a processing module, configured to invoke a preview content of the video according to the preview instruction and to play the preview content in a preview area of the video menu, wherein the preview area does not cover other videos in the video menu.

7. The terminal device according to claim 6, wherein the processing module is configured to:
invoke, according to the preview instruction, a video segment captured from the required video, and
play the video segment in the preview area of the video menu.

8. The terminal device according to claim 6, wherein the processing module is specifically configured to:
invoke, according to the preview instruction, a preview segment formed by at least two frames of the required video, and
play the preview segment in the preview area of the video menu.

9. The receiving device according to claim 6, wherein:
the receiving module is further configured to receive a video playing instruction during the process of playing the preview content in the preview area of the video menu; and
the processing module is further configured to play the video on a newly loaded playing interface according to the video playing instruction.

10. The receiving device according to claim 6, wherein:
the receiving module is further configured to receive a video exit instruction during the process of playing the preview content in the preview area of the video menu; and
the processing module is further configured to stop playing the preview content according to the video exit instruction, and to restore the video to an initial display state for the user to browse.
